(19) United States
(12) Patent Application Publication
(10) Pub. No.: US 2012/0074706 A1
(43) Pub. Date: Mar. 29, 2012

(54) Mutual-Rotating Power System

(76) Inventor: Kuo-Yuan Lynn, Tainan City (TW)

(21) Appl. No.: 12/894,116

(22) Filed: Sep. 29, 2010

(51) Int. Cl. F03D 9/00

(52) U.S. Cl. 290/55

(57) ABSTRACT

A mutual-rotating power system for converting solar energy and wind energy into kinetic energy includes a plurality of rotary power mechanisms. Each of the rotary power mechanisms includes an upright fixed shaft, and a rotary device including a plurality of spaced-apart outer blades that surround rotatably the fixed shaft. Each of the outer blades of each of the rotary power mechanisms and each of the outer blades of an adjacent one of the rotary power mechanisms are configured to have magnetic repulsion therebetween when they are rotated close to each other, thereby driving the rotary devices of the adjacent ones of the rotary power mechanisms to rotate in first and second rotational directions.

### BACKGROUND OF THE INVENTION

1. Field of the Invention

The invention relates to a mutual-rotating power system, more particularly to a mutual-rotating power system capable of converting solar energy and wind energy into kinetic energy.

2. Description of the Related Art

A mutual-rotating power system is for converting different kinds of energy (such as solar energy, wind energy, chemical energy, thermal energy, and so on) into kinetic energy through a rotary mechanism thereof. For example, the mutual-rotating power system may be a wind turbine that can be driven rotatably by wind to thereby convert wind energy into kinetic energy, which can be further converted into electricity.

However, the efficiency of energy conversion and power output may be affected adversely by mechanical friction and air resistance during rotation of rotary power mechanisms.

### SUMMARY OF THE INVENTION

Therefore, the object of the present invention is to provide a mutual-rotating power system that can reduce friction and air resistance during operation of the mutual-rotating power system and that can improve energy converting efficiency and result in a greater power output.

According to the present invention, there is provided a mutual-rotating power system for converting solar energy and wind energy into kinetic energy. The mutual-rotating power system includes a plurality of rotary power mechanisms. Each of the rotary power mechanisms includes a fixed shaft unit including an upright fixed shaft, and a rotary device. The rotary device includes a plurality of angularly spaced-apart outer blades surrounding rotatably the fixed shaft. Each of the outer blades of each of the rotary power mechanisms and each of an adjacent one of the rotary power mechanisms are configured to have magnetic repulsion therebetween when they are rotated close to each other, thereby driving the rotary device of said one of the rotary power mechanisms and the rotary device of the adjacent one of the rotary power mechanisms to rotate in first and second rotational directions.

### BRIEF DESCRIPTION OF TEE DRAWINGS

Other features and advantages of the present invention will become apparent in the following detailed description of the preferred embodiments with reference to the accompanying drawings, of which:

FIG. 1 is a schematic top view of a first preferred embodiment of a mutual-rotating power system according to the present invention;

FIG. 2 is a perspective view of a rotary power mechanism of the first preferred embodiment;

FIG. 3 is a partly sectional view of the rotary power mechanism of the first preferred embodiment;

FIG. 4 is a sectional view of the rotary power mechanism of the first preferred embodiment;

FIG. 5 is a fragmentary sectional view of the rotary power mechanism of the first preferred embodiment;

FIG. 6 is a schematic sectional view of the first preferred embodiment taken along line VI-VI in FIG. 3;

FIG. 7 is another schematic sectional view of the first preferred embodiment taken along line VII-VII in FIG. 3;

FIG. 8 is a schematic fragmentary side view of two rotary power mechanisms of the first preferred embodiment;

FIG. 9 is a schematic top view of a second preferred embodiment of the mutual-rotating power system according to the present invention, illustrating a plurality of rotary power mechanisms arranged as a honeycomb;

FIG. 10 is a fragmentary partly enlarged view of FIG. 9;

FIG. 11 is a schematic fragmentary side view of two of the rotary power mechanisms of the second preferred embodiment;

FIG. 12 is a perspective view of a rotary power mechanism of a third preferred embodiment of the mutual-rotating power system according to the present invention;

FIG. 13 is a schematic top view of the third preferred embodiment assembled with a space capsule;

FIG. 14 is a schematic side view of the third preferred embodiment; and

FIG. 15 is a schematic side view to illustrate a modification of the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

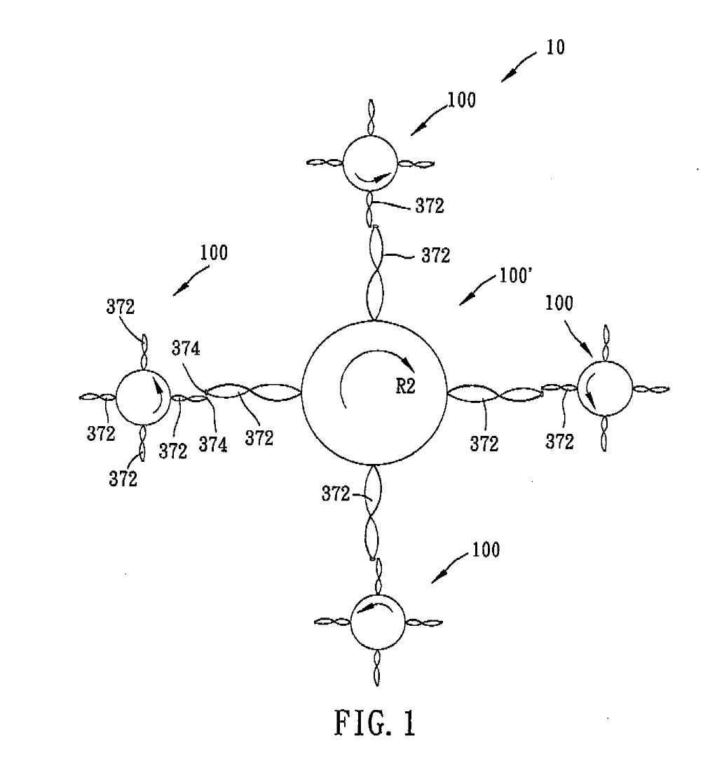

A first preferred embodiment of a mutual-rotating power system 10 according to the present invention is shown in FIG. 1. The mutual-rotating power system 10 comprises four angularly spaced-apart small rotary power mechanisms 100, and one large rotary power mechanism 100′ that has dimensions greater than those of the small rotary power mechanisms 100 and that is surrounded by the small rotary power mechanisms 100. In this embodiment, the rotary power mechanisms 100, 100′ are vertical-axis wind turbines that occupy a smaller volume compared to horizontal-axis wind turbines.

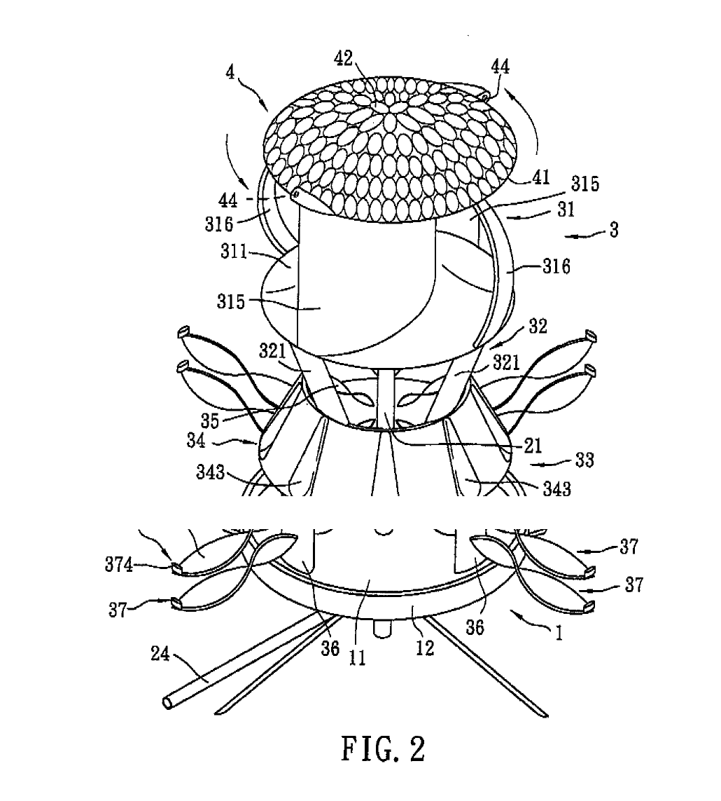

The structures of the small rotary power mechanisms 100 and the large rotary power mechanism 100′ are substantially the same. Therefore, in the following description, only the large rotary power mechanism 100′ and one of the small rotary power mechanisms 100 will be described for the sake of brevity. Further referring to FIGS. 2 to 5, the small rotary power mechanism 100 includes a base seat 1, a fixed shaft unit 2, a rotary device 3, an air-collecting device 4, a generator 5, and a purifying device 6.

The base seat 1 includes a main seat body 11, and a magnetized annular flange 12 extending upwardly from a periphery of the main seat body 11. The fixed shaft unit 2 includes an upright fixed shaft 21.

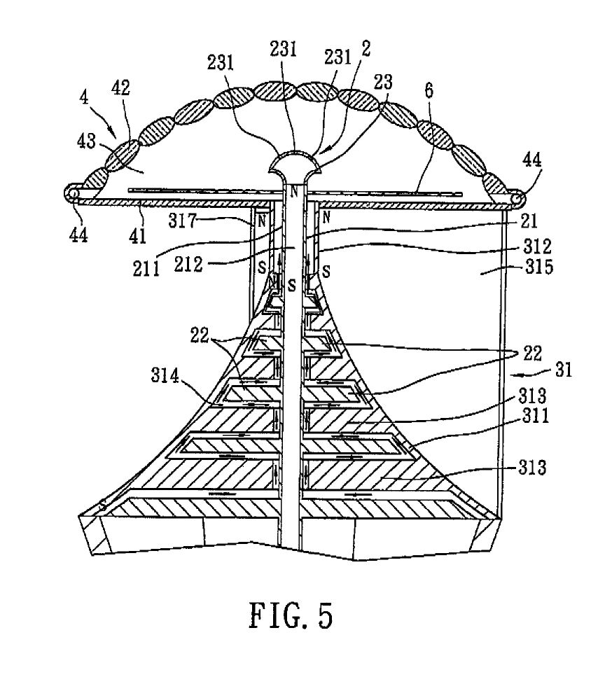

The rotary device 3 includes a first windmill unit 31, a second windmill unit 32, and a third windmill unit 33. The first windmill unit 31 is disposed rotatably around the fixed shaft 21 and includes two first blades 315 that are driven rotatably by wind, a surrounding wall 311 that surrounds the fixed shaft 21 and that is configured as a tapered tube (i.e., the surrounding wall 311 has a diameter that reduces gradually toward a top end thereof), and a plurality of rotating blades 313 extending from the surrounding wall 311 toward the fixed shaft 21. The rotating blades 313 are vertically spaced apart from each other (see FIG. 5).

The air-collecting device 4 is co-rotatable with the first windmill unit 31 and includes abase wall 41, and a light-focusing wall 42 that is disposed over and connected to the base wall 41, that cooperates with the base wall 41 to define a sealed air compartment 43 therebetween, and that is formed with two diametrically opposed jetting holes 44 in fluid communication with the air compartment 43.

The first windmill unit 31 further includes a connecting wall 312 that extends upwardly from a top end of the surrounding wall 311 for connection to the air-collecting device 4, and that surrounds spacedly the fixed shaft 21. The fixed shaft unit 2 further includes a plurality of fixed blades 22 extending radially and outwardly from the fixed shaft 21 toward the surrounding wall 311, and vertically spaced apart from each other. The fixed blades 22 and the rotating blades 313 are alternately arranged in the vertical direction. The connecting wall 312 cooperates with the surrounding wall 311 and the fixed shaft 21 to define an air passage 314 thereamong.

The fixed shaft 21 has an annular shaft wall 211 that defines an axial passage 212 in fluid communication with the air compartment 43. The fixed shaft unit 2 further includes a delivery pipe 24 and a sprayer 23. The delivery pipe 24 is in fluid communication with the axial passage 212 for supplying gas into the axial passage 212 and, thus, the air compartment 43. The sprayer 23 is disposed in the air compartment 43 and connected to a top end of the fixed shaft 21. The sprayer 23 includes a plurality of openings 231 that permit the gas to flow from the axial passage 212 into the air compartment 43 therethrough.

Rotation of the first blades 315 of the first rotary unit 31 results in upward flow of air into the air compartment 43 to further pressurize the air in the air compartment 43 to thereby allow the air to be jetted out of the air compartment 43 through the jetting holes 44 in opposite directions so as to rotate the air-collecting device 4 and, thus, the rotary device 3 about the fixed shaft 21.

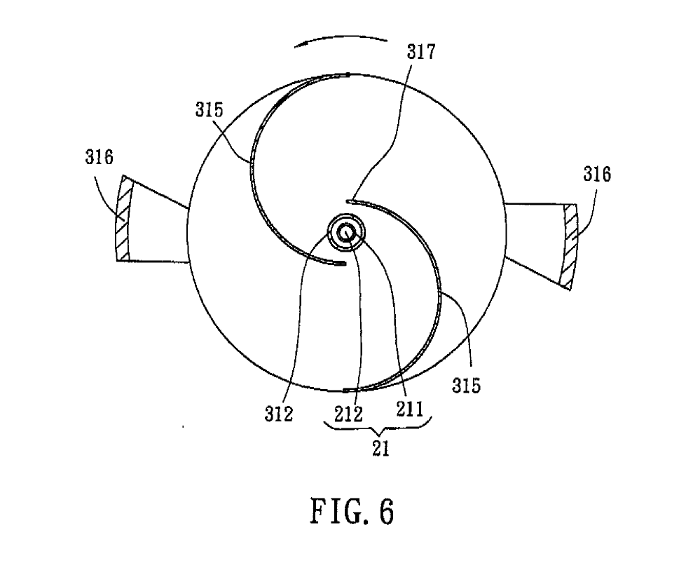

The first windmill unit 31 further includes two auxiliary blades 316 disposed around the first blades 315 and each having a shape different from that of each of the first blades 315. Further referring to FIG. 6, the first blades 315 are Savonius type blades. Each of the first blades 315 has an inner end 317 adjacent to and spaced apart from the fixed shaft 21. The auxiliary blades 316 are Darrieus type blades that extend parabolically and surround the first blades 315. Each of the auxiliary blades 316 has a top end connected to a bottom of the air-collecting device 4, and a lower end connected to a bottom of the surrounding wall 311. The efficiency of Darrieus type blades (auxiliary blades 316) is better than that of Savonius type blades (first blades 315). Thus, the auxiliary blades 316 can enhance a rotating power of the windmill device 3 and reduce air resistance of convex side surfaces of the first blades 315.

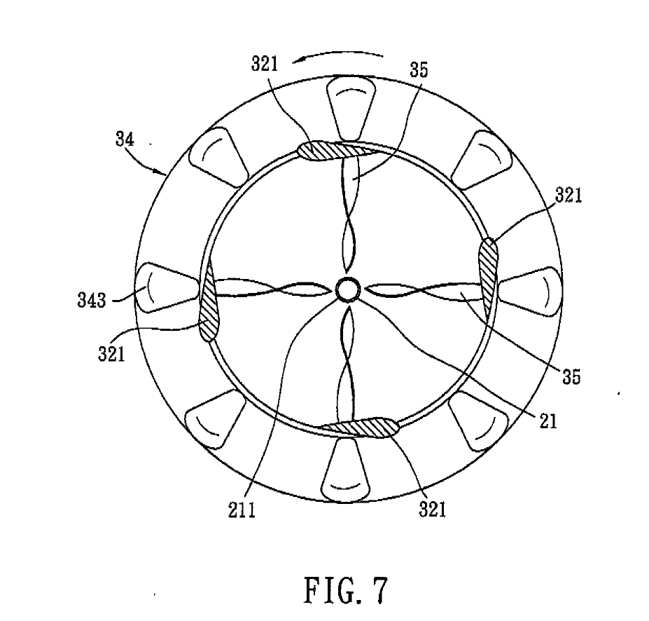

The second windmill unit 32 is disposed under and connected fixedly to the first windmill unit 31 for co-rotation therewith. Further referring to FIG. 7, the second windmill unit 32 includes four angularly equidistant second blades 321 disposed around the fixed shaft 21. The second blades 321 are Darrieus type blades each having a cross-section that is shaped as a stretched water drop. The second blades 321 are inclined relative to the fixed shaft 21, and extend downwardly and inwardly from the first windmill unit 31. Each of the second blades 321 has a top end connected fixedly to a bottom end of the surrounding wall 311 of the first windmill unit 31, and a bottom end fixedly connected to a top end of the third windmill unit 33.

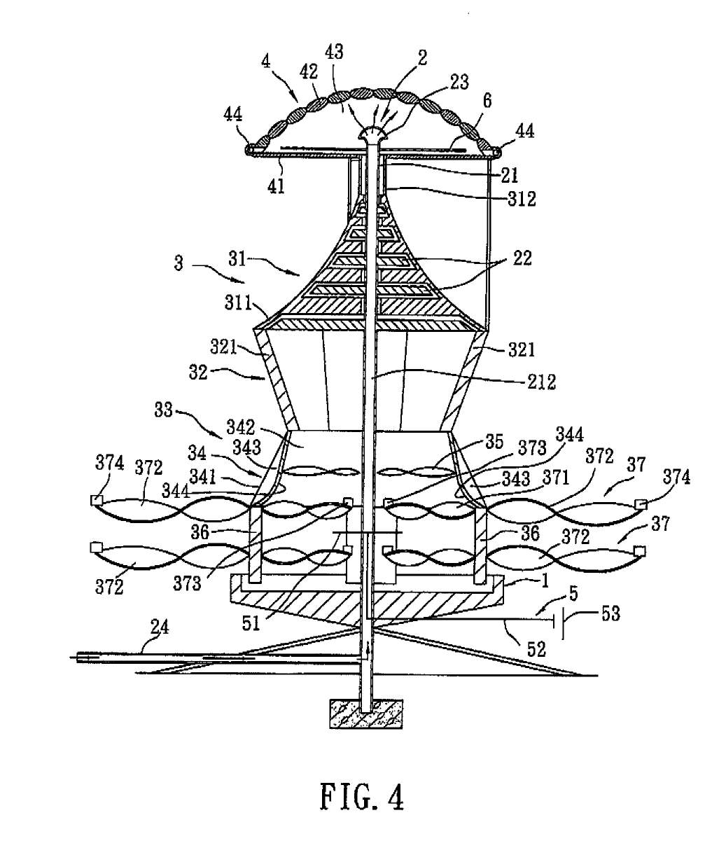

The third windmill unit 33 is disposed under the second windmill unit 32. The third windmill unit 33 includes a wind-guiding seat 34 rotatable relative to the fixed shaft 21, four angularly spaced-apart Darrieus type blades 36 disposed under and connected fixedly to the wind-guiding seat 34, and four enhancing blades 35. The wind-guiding seat 34 has a diameter that reduces gradually toward the second windmill unit 32 and includes a downwardly diverging frustoconical surrounding wall 341 that defines an air-guiding space 342 (see FIG. 4). The surrounding wall 341 has an outer surface formed with a plurality of guiding grooves 393, and an inner surface that confronts the fixed shaft 21 and that is formed with a plurality of convex surface portions 344 aligned with the guiding grooves 343, respectively. The enhancing blades 35 are spaced apart from each other angularly and equidistantly and extend from the inner surface of the surrounding wall 341 toward the fixed shaft 21.

The third windmill unit 33 further includes two blade units 37 spaced-apart from each other along the vertical direction. Each of the blade units 37 includes four inner blades 371 each extending from a respective one of the Darrieus type blades 36 toward the fixed shaft 21 and adjacent to and spaced apart from the fixed shaft 21, and four outer blades 372 each extending from the respective one of the Darrieus type blades 36 away from the fixed shaft 21.

Each of the inner blades 371 has an inner magnetized portion 373 projecting upwardly from an end thereof adjacent to the fixed shaft 21. Each of the outer blades 372 has an outer magnetized portion 374 projecting upwardly from an end thereof distal from the fixed shaft 21. Each of the inner blades 371 and the outer blades 372 is configured as a propeller blade.

Referring back to FIG. 4, a generator 5 is connected to the rotary device 3 for converting rotational kinetic energy of the rotary device 3 into electric power. The generator 5 includes a coil 51 that is disposed between the blade units 37 and that generates induced current as a result of rotation of the blade units 37 of the third windmill unit 33, a conductive wire 52 electrically connected to the coil 51, and a rechargeable battery 53 electrically connected to the conductive wire 52.

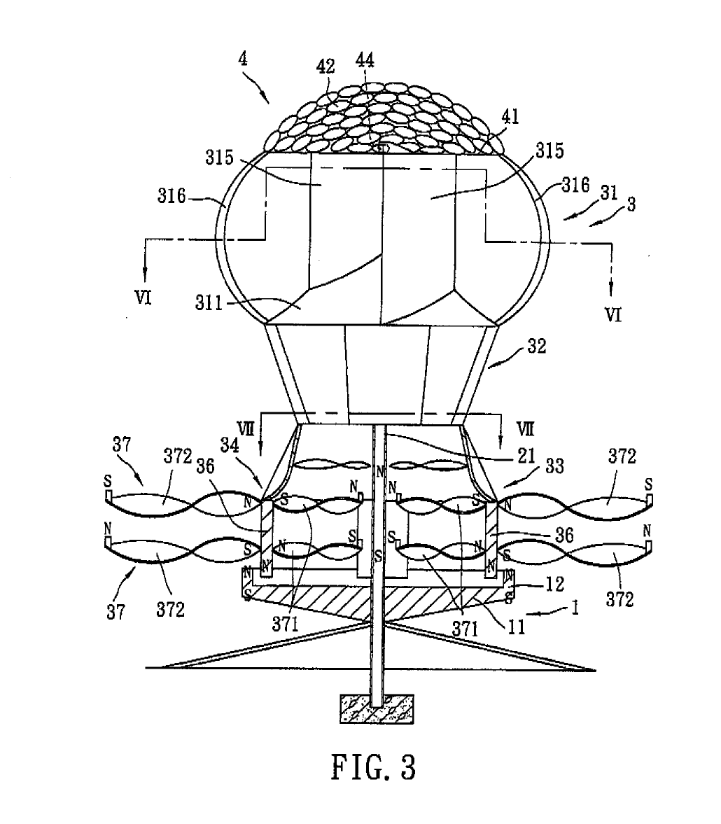

Referring back to FIG. 3, the magnetized annular flange 12 has a top end having a first magnetic polarity, and a bottom end having a second magnetic polarity. In this preferred embodiment, the first magnetic polarity is (N) pole, and the second magnetic polarity is (S) pole, as indicated by (N), (S) respectively in FIGS. 3 and 5.

A bottom end of each of the Darrieus type blades 36 has the first magnetic polarity (N). As such, a magnetic repulsive force is generated between the top end of the magnetized annular flange 12 of the base seat 1 and the bottom end of each of the Darrieus type blades 36 (i.e., the top end of the magnetized annular flange 12 and the Darrieus type blades 36 have magnetic repulsion therebetween) so as to allow the third windmill unit 33 to levitate above the base seat 1. Therefore, when the third windmill unit 33 rotates relative to the base seat 1, a friction force between the third windmill unit 33 and the base seat 1 is avoided.

Moreover, magnetic repulsive forces are generated between the inner magnetized portions 373 of the inner blades 371 and the fixed shaft 21 (i.e., the inner magnetized portions 373 of the inner blades 371 and the fixed shaft 21 have magnetic repulsion therebetween), thus avoiding a friction force and reducing vibration and noise during rotation of the third windmill unit 33. Moreover, as shown in FIG. 5, the inner end 317 of each of the first blades 315 and the fixed shaft 21 have identical magnetic polarities, such that magnetic repulsive forces are generated between the fixed shaft 21 and the inner ends 317 of the first blades 315. Furthermore, a magnetic repulsive force is also generated between the surrounding wall 311 of the first windmill unit 31 and the fixed shaft 21.

Referring to FIGS. 2, 4, and 5, the light-focusing wall 42 of the air-collecting device 4 is made of a light-transmissive material and is composed of a plurality of interconnected light-focusing lenses that are capable of focusing sunlight into the air compartment 43 to thereby heat air in the air compartment 93. The jetting holes 44 permit the heated air to be jetted out of the air compartment 43 therethrough in opposite directions so that a rotational kinetic energy is generated and a force couple effect is created to further rotate the air-collecting device 4 and thus the rotary device 3. Rotation of the rotating blades 313 results in upward flow of air into the air compartment 43 via the air passage 319. When the airflows in the air passage 314, since the diameter of the surrounding wall 311 is reduced gradually and upwardly, the air in the air passage 314 is pressurized. The air flowing into the air compartment 43 is further pressurized and then jetted out of the air compartment 43 through the jetting holes 44 so as to rotate the air-collecting device 4 and, thus, the rotary device 3.

When the third windmill unit 33 rotates, the blade units 37 are rotated about the fixed shaft 21. The outer blades 372 of the blade units 37 force air to flow into the second windmill unit 32. At the same time, rotation of the inner blades 371 results in upward flow of air into the wind-guiding seat 34. With the aid of the convex surface portions 344 and the enhancing blades 35 of the wind-guiding seat 34, the speed of air flowing into the second windmill unit 32 can be increased.

The outer blades 372 of the blade units 37 extend horizontally and outwardly, thus improving stability during rotation of the rotary device 3. The coil 51 generates induced current as a result of rotation of the blade units 37 of the third windmill unit 33. The conductive wire 52 is electrically connected to the coil 51, and permits the induced current to flow from the coil 51 into the rechargeable battery 53 therethrough.

It should be noted that the generator 5 can be replaced with a pumping station or a water-piping device in other embodiments.

The purifying device 6 is disposed in the air compartment 43 and includes a filtering material such as NaOH and Ca(OH)₂ for filtering out impurities such as CO₂ in air before the air flows out of the air compartment 43. In this embodiment, the purifying device 6 is disposed directly above and adjacent to a top end of the air passage 314.

The delivery pipe 24 is in fluid communication with the axial passage 212 of the fixed shaft 21. Industrial exhaust gas as well as steam and other gas generated by other alternative sources of energy such as terrestrial heat, may be supplied into the axial passage 212 through the delivery pipe 24 to drive the air-collecting device 4 to rotate, such that the rotary device 3 can be rotated when the weather is neither sunny nor windy.

It should be further noted that the second windmill device 32 and the third windmill device 33 may be omitted in other embodiments of this invention.

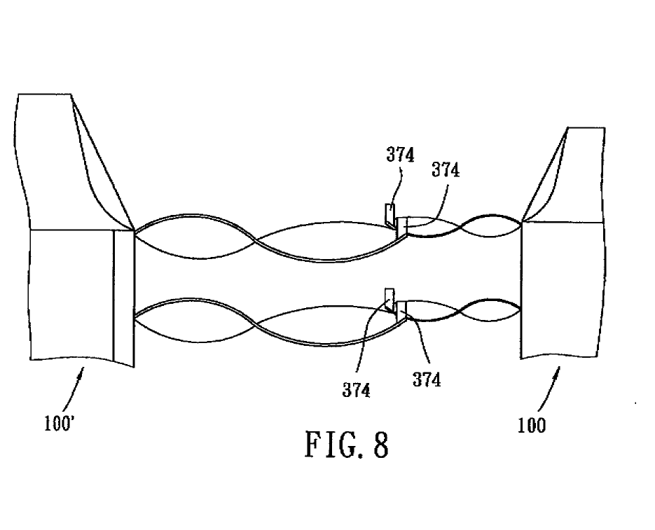

Referring back to FIG. 1, and further referring to FIG. 8, the outer magnetized portions 374 of the outer blades 372 of the small rotary power mechanism 100 and those of the large rotary power mechanism 100′ are configured to have identical magnetic polarities such that, when the outer blades 372 of the small rotary power mechanism 100 is rotated in a first rotating direction (R1) close to those of the large rotary power mechanism 100′, magnetic repulsion is generated therebetween. As a result, the outer magnetized portions 374 of the large rotary power mechanism 100′ are driven to rotate in a second rotational direction (R2) that is opposite to the first rotational direction (R1) through a force couple effect due to the magnetic repulsive force between the large rotary power mechanism 100′ and the four small rotary mechanisms 100. It should be noted that the first blades 31 of the four small rotary power mechanisms 100 in this embodiment are arranged to have the same convex orientation to ensure that the small rotary power mechanisms 100 are rotated by wind in the same rotational direction (i.e., the first rotational direction (R1)), and that the first blades 31 of the large rotary power mechanism 100′ are arranged to have a convex orientation opposite to that of the first blades 31 of the small rotary mechanisms 100 to ensure that the large rotary power mechanism 100′ is rotated in the second rotational direction (R2). To sum up, the large rotary power mechanism 100′ can be rotated through the magnetic repulsion between the large rotary power mechanism 100′ and the four small rotary power mechanisms 100 instead of being rotated directly by wind. Since the wind energy for driving rotation of the small rotary power mechanisms 100 is less than that for driving rotation of the large rotary power mechanism 100′, and since the force couple effect compensates mechanical friction and air resistance during the rotation of the large rotary power mechanism 100′, the efficiency of the mutual-rotating power system 10 of this invention can be improved.

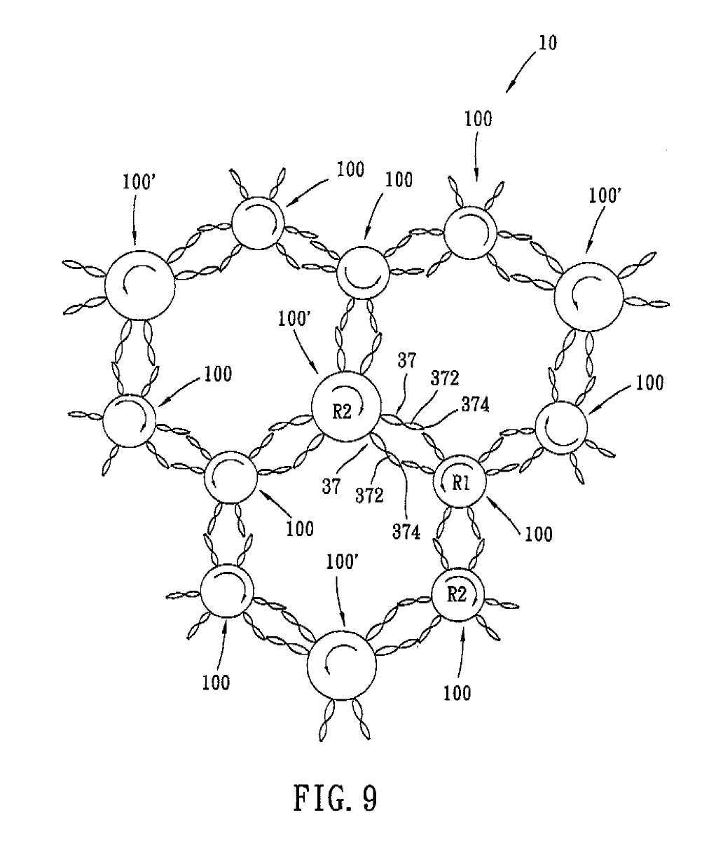

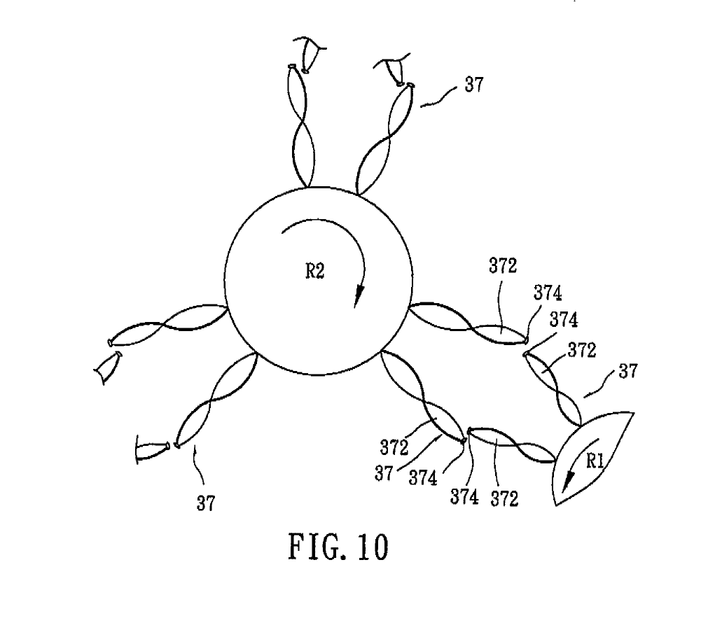

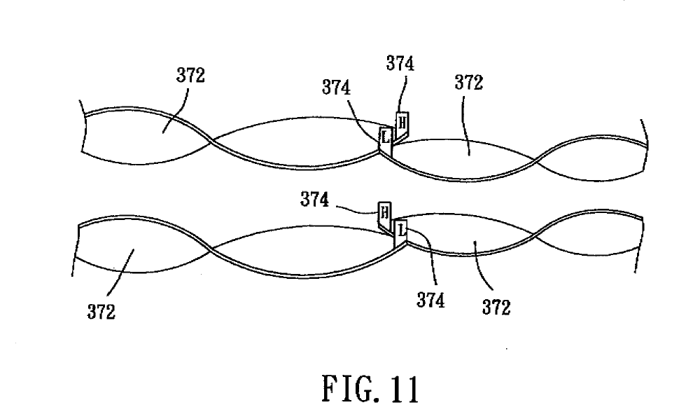

As shown in FIGS. 9 to 11, a second preferred embodiment of the mutual-rotating power system according to the present invention has a structure similar to that of the first embodiment. The main difference between this embodiment and the first embodiment resides in the following. In this embodiment, the mutual-rotating power system 10 comprises four large rotary power mechanisms 100′ and nine small rotary power mechanisms 100 that are arranged as a honeycomb (see FIG. 9). For each of the rotary power mechanisms 100, 100′, the third windmill unit (not shown) includes three blade units 37 angularly spaced-apart from each other. Each of the blade units 37 includes two outer blades 372 that are spaced apart from each other in the vertical direction and a circumferential direction and that extend from a respective one of the Darrieus type blades (not shown). One of the outer magnetized portions 374 (indicated by H in FIG. 11) of each of the blade units 37 has a magnetic strength larger than that of the other one of the outer magnetized portions 374 (indicated by L in FIG. 11) of a corresponding one of the blade units 37. Each of the rotary power mechanisms 100, 100′ may have more than three blade units 37 in other embodiments of this invention.

For each of the blade units 37 of the rotary power mechanisms 100, 100′ that are rotatable in the first rotational direction (R1) (illustrated in the right of FIG. 11), the outer blades 372 are disposed between those of an adjacent one of the rotary power mechanisms 100, 100′ that is rotatable in the second rotational direction (R2) (illustrated in the left of FIG. 11) when these two blade units 37 are rotated to positions close to each other. At that time, the outer magnetized portion 374 of the outer blade 372 of the left rotary power mechanism 100, 100′ (which is rotatable in the second rotational direction (R2)) having the higher magnetic strength is disposed adjacent to that of the outer blade 372 of the right rotary power mechanism 100, 100′ (which is rotatable in the first rotational direction (R1)), while the outer magnetized portion 374 of the outer blade 372 of the left rotary power mechanism 100, 100′ having the lower magnetic strength is disposed adjacent to that of the outer blade 372 of the right rotary power mechanism 100, 100′.

Therefore, the outer magnetized portion 374 of the left rotary power mechanism 100, 100′ that has the higher magnetic strength pushes the corresponding outer magnetized portion 374 of the right rotary power mechanism 100, 100′ that has the lower magnetic strength to rotate together with the corresponding rotary power mechanism 100, 100′ in the second rotational direction (R2), and the outer magnetized portion 379 of the right rotary power mechanism 100, 100′ that has the higher magnetic strength pushes the corresponding outer magnetized portion 374 of the left rotary power mechanism 100, 100′ that has the lower magnetic strength to rotate together with the corresponding rotary power mechanism 100, 100′ in the first rotational direction (R1).

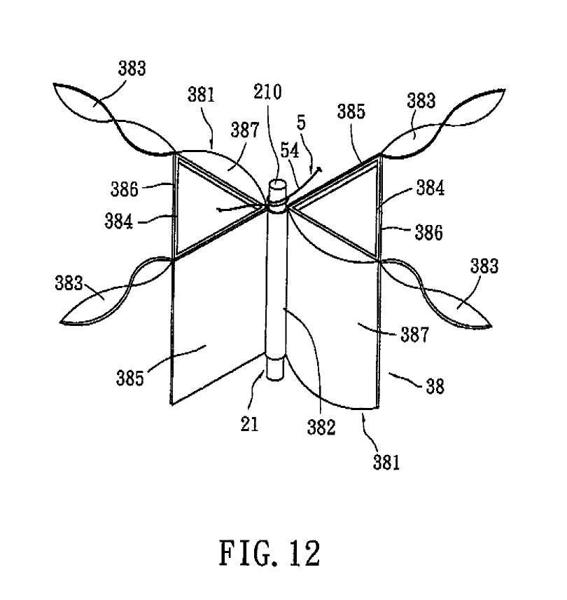

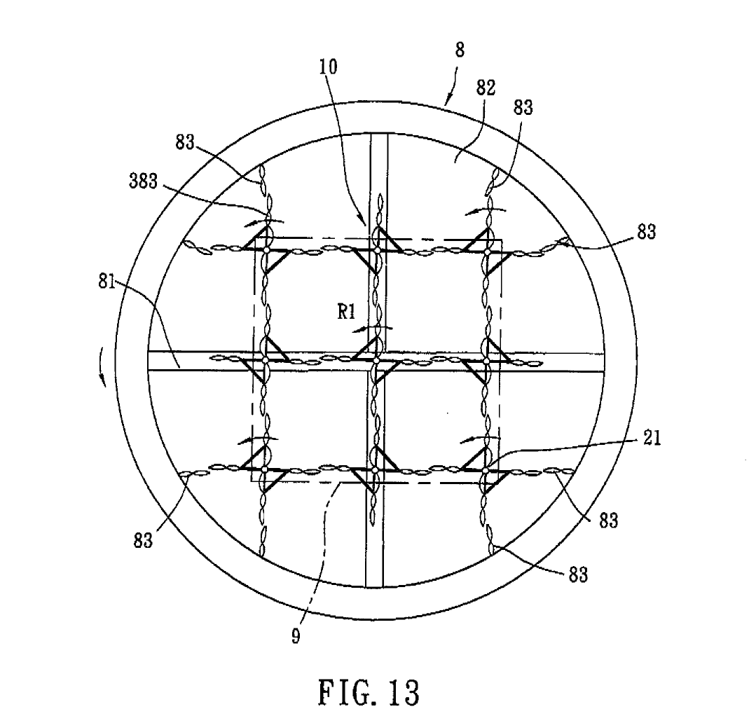

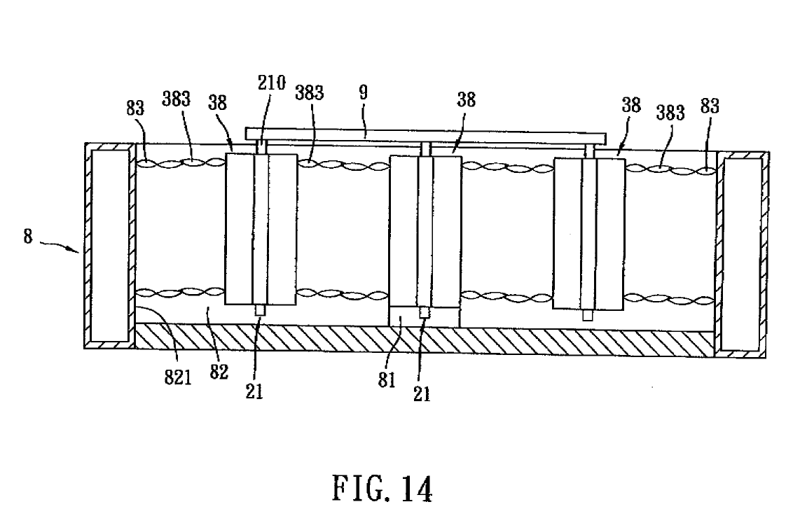

Referring to FIGS. 12 to 14, a third preferred embodiment of the mutual-rotating power system 10 according to the present invention has a structure similar to that of the first embodiment. In this embodiment, the mutual-rotating power system 10 is disposed in a zero-gravity outer space and comprises nine rotary power mechanisms 100. The rotary power mechanisms 100 are disposed within a space capsule 8, and are arranged in three rows with three rotary power mechanisms 100 in each row.

Each of the rotary power mechanisms 100 includes a rotary device 38 that is driven rotatably about the fixed shaft 21 by radiation pressure of light, which is similar to the way to drive movement of solar sails. The generator 5 of each of the rotary power mechanisms 100 is connected to the rotary device 38 of a corresponding one of the rotary power mechanisms 100 for converting rotational kinetic energy of the rotary device 38 into electric power. Each of the generators 5 includes a coil 54 that is wound on the fixed shaft 21 of the respective one of the rotary power mechanisms 100 and that generates induced current as a result of rotation of the rotary device 38.

Each of the rotary devices 38 includes a pair of light-receiving blades 381, a bushing 382 rotatably sleeved on the fixed shaft 21 and connected to the light-receiving blades 381, and two pairs of rotatable outer blades 383. Each pair of the rotatable outer blades 383 is provided on a respective one of the light-receiving blades 381. Each of the light-receiving blades 381 includes a magnetized supporting frame 384 that is shaped as a triangular prism and that has three rectangular frame portions, two planar plates 385, 386 that are disposed respectively on two of the rectangular frame portions of the supporting frame 384, and a convex plate 387 that is disposed on the other one of the rectangular frame portions of the supporting frame 384 between the planar plates 385, 386. The convex plates 387 of the light-receiving blades 381 of each of the rotary devices 39 are disposed opposite to each other in a direction transverse to the fixed shaft 21.

For each light-receiving blade 381, the planar plate 385 and the convex plate 387 are connected to the bushing 382. In this embodiment, the planar plates 385, 386 are solar panels that convert solar energy into electricity, and the convex plates 387 are made of a transparent material and are configured to focus sunlight. The planar plates 385, 386 can be configured to have reflected surfaces to be pushed by radiation pressure of light.

For each light-receiving blade 381, the pair of the outer blades 383 are mounted respectively to a junction of the planar plates 385, 386 and a junction of the convex plate 387 and the planar plate 386. In this embodiment, the outer blades 383 are electromagnets, and the magnetic force thereof may be that resulting from the induced current generated by the coil 54 during rotation of the corresponding rotary device 38 or the light-receiving blades 381. The magnetic strength of the outer blades 383 is controlled by the amount of the current, such that the rotation speed of the outer blades 383 can be controlled accordingly.

In this embodiment, the mutual-rotating power system 10 further includes a grid-shaped frame 9 disposed above the rotary power mechanisms 100, and the fixed shaft 21 of each of the rotary power mechanisms 100 has a top end 210. The rotary power mechanisms 100 are interconnected to each other at the top ends 210 thereof by the grid-shaped frame 9. The space capsule 8 includes a crisscross frame 81 that is disposed under the rotary power mechanisms 100, a sealed cabin 821 that defines an inner space 82 therein, and a plurality of inner blades 83 that extend inwardly from the cabin 821. The inner blades 83 are electromagnets and have identical structure as the outer blades 383 of the rotary devices 38.

The crisscross frame 81 is disposed in the inner space 82, is connected fixedly to the cabin 821, and is connected fixedly and co-rotatably to one of the rotary power mechanisms 100 that is disposed at the center of the three-row arrangement. In this embodiment, the rotary power mechanism 100 that is connected to the crisscross frame 81 is rotatable in the first direction (R1).

Further, four of the rotary power mechanisms 100 that are disposed at corner positions of the three-row arrangement are rotatable in the first direction (R1) as well. Magnetic repulsive force is generated between the outer blades 383 of the four corner rotary power mechanisms 100 and the inner blades 83 when the outer blades 383 of these corner rotary power mechanisms 100 are rotated close to the inner blades 83 so as to drive the inner blades 83 and the inner space 82 to rotate in the first rotational direction (R1). As a result, the rotation of the space capsule 9 in the zero-gravity outer space and a centrifugal force is generated, such that an artificial gravitational effect is formed inside the inner space 82. Consequently, astronauts in the space capsule 8 when traveling in the outer space would feel like living on Earth.

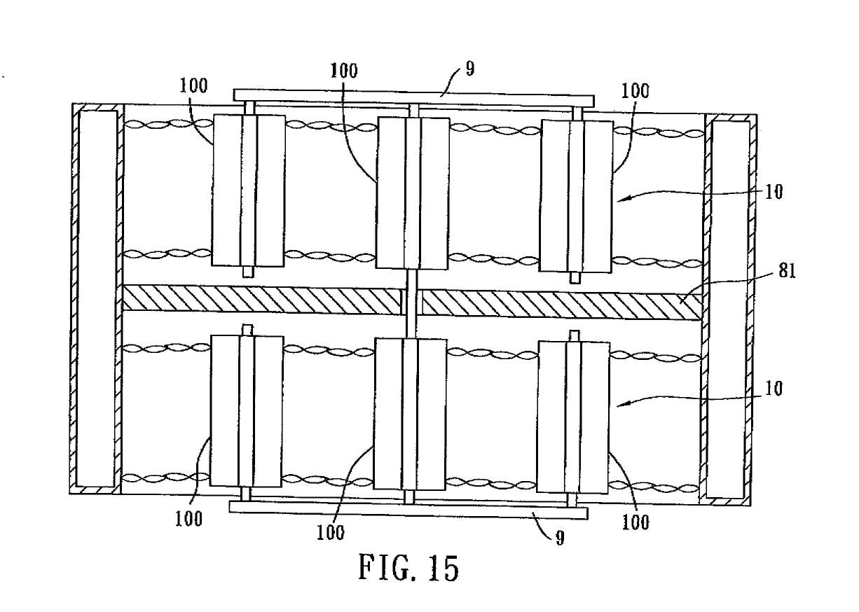

Referring to FIG. 15, a modification of the third preferred embodiment is shown to include two of the mutual-rotating power systems that are connected to each other. The grid-shaped frame 9 of bottom one of the mutual-rotating power systems 10 is disposed under the corresponding rotary power mechanisms 100, and the grid-shaped frame 9 of the top one of the mutual-rotating power systems 10 is disposed over the corresponding rotary power mechanisms 100. The crisscross frame 81 of the space capsule 8 is disposed between the mutual-rotating systems 10.

To sum up, the mutual-rotating power system 10 of the present invention is capable of converting solar energy, wind energy or even other alternative energy sources such as terrestrial heat into kinetic energy, and employs magnetic repulsive force to drive rotations of the rotary power mechanisms 100 to reduce friction force generated during use to thereby improve energy conversion efficiency. Moreover, the generated kinetic energy can be further utilized in generation of electricity, ventilation, dissipation of heat, and filtration of air and gas.

While the invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A mutual-rotating power system for converting solar energy and wind energy into kinetic energy, said mutual-rotating power system comprising a plurality of rotary power mechanisms, each of said rotary power mechanisms including:
a fixed shaft unit including an upright fixed shaft; and
a rotary device including a plurality of spaced-apart outer blades that surround rotatably said fixed shaft, each of said outer blades of each of said rotary power mechanisms and each of said outer blades of an adjacent one of said rotary power mechanisms being configured to have magnetic repulsion therebetween when they are rotated close to each other, thereby driving said rotary device of said one of said rotary power mechanisms and said rotary device of said adjacent one of said rotary power mechanisms to rotate in first and second rotational directions.

2. The mutual-rotating power system as claimed in claim 1, wherein each of said outer blades has an outer magnetized portion at an end thereof distal from said fixed shaft of a corresponding one of said rotary power mechanisms, said outer magnetized portion of each of said outer blades of each of said rotary power mechanisms and said outer magnetized portion of each of said outer blades of the adjacent one of said rotary power mechanisms having magnetic repulsion therebetween when they are rotated close to each other.

3. The mutual-rotating power System as claimed in claim 2, wherein:
said rotary device of each of said rotary power mechanisms has a plurality of blade units, each including two of said outer blades that are spaced apart from each other in vertical and circumferential direction, said outer magnetized portions of said outer blades of each of said blade units having higher and lower magnetic strength, respectively;
said mechanisms of said mutual-rotating power system including first rotary power mechanisms that include said rotary devices rotatable in the first rotational direction, and second rotary power mechanisms that include said rotary devices rotatable in the second rotational direction; and
said outer blades of each of said blade units of said first rotary power mechanisms are disposed between those of the adjacent one of said blade units of said second rotary power mechanisms when one of said blade units of said first rotary power mechanisms is at a position close to one of said blade units of said second rotary power mechanisms so that said outer magnetized portion of said outer blade of said first rotary power mechanism having the higher magnetic strength is disposed adjacent to that of said second rotary power mechanism having the lower magnetic strength, and that said outer magnetized portion of said outer blade of said first rotary power mechanism having the lower magnetic Strength is disposed adjacent to that of said second rotary power mechanism having the higher magnetic strength.

4. The mutual-rotating power system as claimed in claim 2, wherein said outer magnetized portions of said blade units are made of permanent magnets and electromagnets.

5. The mutual-rotating power system as claimed in claim 1, wherein each of said rotary power mechanisms further comprises:
an air-collecting device disposed above said rotary device and permitting air to flow upwardly therein; and
a purifying device disposed in said air-collecting device and including a filtering material for filtering out impurities in air.

6. The mutual-rotating power system as claimed in claim 5, wherein said air-collecting device of each of said rotary power mechanisms is co-rotatable with a corresponding one of said rotary device of a corresponding one of said mutual-rotary power system and includes:
a base wall; and
a light-focusing wall that is disposed over and connected to said base wall, that cooperates with said base wall to define an air compartment therebetween, that is formed with two diametrically opposed jetting holes in fluid communication with said air compartment, and that is configured to focus sunlight into said air compartment so that air in said air compartment is heated and pressurized to be jetted out of said air compartment through said jetting holes for driving rotation of said air-collecting device.

7. The mutual-rotating power system as claimed in claim 6, wherein said fixed shaft of said fixed shaft unit of each of said rotary power mechanisms defines an axial passage in fluid communication with said air compartment of said air-collecting device of a corresponding one of said rotary power mechanisms, said fixed shaft unit of each of said rotary power mechanisms further including a delivery pipe in fluid communication with said axial passage in said fixed shaft for supplying gas into said axial passage and said air compartment.

8. The mutual-rotating power system as claimed in claim 7, wherein said fixed shaft unit of each of said rotary power mechanisms further includes a sprayer that is disposed in said air compartment and connected to atop end of said fixed shaft, and that permits the gas to flow from said axial passage into said air compartment therethrough.

9. The mutual-rotating power system as claimed in claim 1, wherein said rotary device of each of said rotary power mechanisms further includes a wind-guiding seat that is rotatable relative to said fixed shaft, and a plurality of angularly spaced-apart Darrieus type blades that are disposed under and connected fixedly to said wind-guiding seat for guiding air to flow therethrough and upwardly into said air compartment, each of said outer blades having an inner end connected to an outer surface of a corresponding one of said Darrieus type blades.

10. The mutual-rotating power system as claimed in claim 9, wherein said rotary device of each of said rotary power mechanisms further includes a plurality of inner blades, each of said inner blades extending from a respective one of said Darrieus type blades toward said fixed shaft of a corresponding one of said rotary power mechanisms, and having an inner magnetized portion at an end thereof adjacent to said fixed shaft so as to have magnetic repulsion therebetween.

11. The mutual-rotating power system as claimed in claim 10, wherein each of said rotary power mechanisms further comprises a generator that is connected to said rotary device, said generator including
a coil that generates induced current as a result of the rotation of said inner blades,
a conductive wire that is electrically connected to said coil, and
a rechargeable battery that is electrically connected to said conductive wire.

12. The mutual-rotating power system as claimed in claim 9, wherein each of said rotary power mechanisms further comprises a base seat that is disposed under and connected fixedly to said rotary device of a corresponding one of said rotary power mechanisms, and that includes a main seat body and a magnetized annular flange extending upwardly from a periphery of said main seat body such that said magnetized annular flange and said Darrieus type blades of a corresponding one of said rotary power mechanisms have magnetic repulsion therebetween to thereby allow said rotary device to levitate above said base seat.

13. The mutual-rotating power system as claimed in claim 1, wherein said rotary power mechanisms include a large rotary power mechanism and a plurality of angularly spaced-apart small rotary power mechanisms that surround said large rotary power mechanism, magnetic repulsion between said outer blades of said large rotary power mechanism and said outer blades of said small rotary mechanisms resulting in couples on said large rotary power mechanism for driving rotation of said large rotary power mechanism.

14. The mutual-rotating power system as claimed in claim 1, wherein said rotary power mechanisms are adapted to be disposed within a space capsule, the space capsule including a surrounding wall that surrounds said rotary power mechanisms and a plurality of inner blades that are mounted to and extend inwardly from the surrounding wall, said rotary device of each of said rotary power mechanisms further including
a plurality of light-receiving blades that are driven rotatably about said fixed shaft by radiation pressure of light,
said blade units of each of said rotary devices being mounted respectively to outer ends of said light-receiving blades of a respective one of said rotary power mechanisms, said blade units of said rotary power mechanisms being configured such that magnetic repulsion is generated between a part of said blade units and the inner blades of the space capsule when said blade units are rotated close to the inner blades, thereby driving the space capsule to rotate to form a gravitational field inside the space capsule.
